(19) United States
(12) Patent Application Publication
(10) Pub. No.: US 2025/0026654 A1
(43) Pub. Date: Jan. 23, 2025

(54) SYNTHESES AND USES OF TRI-SUBSTITUTED MONO-HYDROGEN FERROCYANIDES FOR EFFICIENT HYDROXYL RADICAL GENERATORS

(71) Applicant: Walker Cancer Research Institute, Inc., Boynton Beach, FL (US)

(72) Inventor: Eduardo PALOMINO, Troy, MI (US)

(73) Assignee: Walker Cancer Research Institute, Inc., Boynton Beach, FL (US)

(21) Appl. No.: 18/904,920

(22) Filed: Oct. 2, 2024

Related U.S. Application Data
(63) Continuation of application No. 17/139,347, filed on Dec. 31, 2020, now abandoned.

(51) Int. Cl. C01C 3/12; C01B 13/14; C07F 15/02

(52) U.S. Cl. CPC C01C 3/12; C01B 13/14; C07F 15/025

(57) ABSTRACT

Embodiments of the present invention provide for syntheses and uses of tri-substituted mono-hydrogen ferrocyanides for efficient hydroxyl radical generators. For example, the present invention provides for the syntheses of mono-hydrogen ferrocyanides of the general formula M₃HFe(CN)₆ in which iron has an oxidation number of +2 (ferro) and the positive counter-ion, M, belongs mainly to the group of the alkali metals such as Na+, K+and Li+, or to organic alkyl cations such as imidazole derivatives.

### CROSS-REFERENCE TO RELATED APPLICATIONS

This application is a continuation of U.S. application Ser. No. 17/139,347 filed Dec. 31, 2020, the disclosure of which is hereby incorporated in its entirety by reference herein.

### FIELD OF DISCLOSURE

The present invention concerns syntheses and uses of tri-substituted mono-hydrogen ferrocyanides for efficient hydroxyl radical generators.

### BACKGROUND OF THE INVENTION

The generation of hydroxyl radicals has been limited to two methods: UV irradiation of H₂O₂ and the chemical reaction of H₂O₂ with ferrous (Fe⁺²) ions. The first one is highly inefficient and the second, the Fenton reaction, is too fast, highly exothermic and produces many by-products. Several forms of iron have been used in the Fenton reaction but all of them are based on the direct attack of the peroxide on the ferrous (Fe⁺²) ion.

### SUMMARY OF THE INVENTION

The present invention differs from the Fenton reaction in its chemical principle. While the Fenton method is based on the very fast, direct and highly exothermic reaction of the ferrous (Fe⁺²) ion with hydrogen peroxide producing a ferric (Fe⁺³) ion plus multiple oxygenated by-products including hydroxyl radicals, the current invention is based on the transfer of a hydrogen atom from the sphere surrounding a ferrocyanide ion that is oxidized to ferricyanide. The transfer is clean, slow and smooth, and virtually iso-thermic, producing exclusively the hydroxyl radical and the tri-substituted ferricyanide. The only by-product of this reaction is pure oxygen (O₂) and water (H₂O) produced in a secondary reaction of the hydroxyl radical when the concentration of hydrogen peroxide is high. In this regard, the mono-hydrogen ferrocyanides of the present disclosure share some similarity of action with the natural enzyme catalase that converts hydrogen peroxide into oxygen and water in a concentration-dictated manner via a mechanism uncovered and disclosed using the present invention.

The present disclosure comprises the syntheses of mono-hydrogen ferrocyanides of the general formula M₃HFe(CN)₆ in which iron has an oxidation number of +2 (ferro) and the positive counter-ion, M, belongs mainly to the group of the alkali metals such as Na+, K+and Li+, or to organic alkyl cations such as imidazole derivatives. This disclosure also refers to the use of such mono-hydrogen ferrocyanides mostly, but not limited, as hydroxyl radical (OH) generators, a Reactive Oxygen Species (ROS) useful in many applications included, but not limited as bactericides, antifungals, antivirals, anticancer agents, as well as in many mechanistic studies in which the hydroxyl radical has been implied such as in antioxidants like vitamin E, enzymatic processes such as catalase and in chemical syntheses where it can serve the dual purpose of a radical in polymerization reactions and as a hydroxylating agent for the production of important chemicals such as E quinone, hydroxyproline, etc., all of this processes having the advantage of the so called green chemistry in which the by-products are clean compounds such as water. An advantage of the compounds included in the present disclosure is the lack of toxicity of the reagents and products, as well as the purity of the hydroxyl radical produced.

### BRIEF DESCRIPTION OF THE DRAWINGS

Some aspects of the disclosure are herein described, by way of example only, with reference to the accompanying drawings. With specific reference now to the drawings in detail, it is stressed that the particulars shown are by way of example and are for purposes of illustrative discussion of embodiments of the disclosure. In this regard, the description, taken with the drawings, makes apparent to those skilled in the art how aspects of the disclosure may be practiced.

FIG. 1 illustrates a general reaction of the synthesis of mono-hydrogen ferrocyanides from a thiol compound.

FIG. 2 illustrates a general reaction of the synthesis of mono-hydrogen ferrocyanides from an aminophenol compound as a forward reaction, showing also the reverse reaction with the produced mono-hydrogen ferrocyanides with hydrogen peroxide to form the hydroxyl radical, as well as the use of such radical to produce iminoquinones.

FIG. 3 illustrates a general reaction of the synthesis of mono-hydrogen ferrocyanides from a combination of an amine and a phenol compounds as a forward reaction, showing also the reverse reaction with the produced mono-hydrogen ferrocyanides with hydrogen peroxide to form the hydroxyl radical, as well as the use of such radical to produce iminoquinones.

FIG. 4. 4 illustrates (1) a reaction of the general mono-hydrogen ferrocyanides with hydrogen peroxide to produce hydroxyl radicals (OH), water and ferricyanide, the starting material of the mono-hydrogen ferrocyanides and (2) a reaction of the hydroxyl radical (OH) with hydrogen peroxide to produce molecular oxygen and water.

### DETAILED DESCRIPTION OF THE INVENTION

This description is not intended to be a detailed catalog of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. In other instances, well-known structures, interfaces, and processes have not been shown in detail in order not to unnecessarily obscure the invention. It is intended that no part of this specification be construed to affect a disavowal of any part of the full scope of the invention. Hence, the following descriptions are intended to illustrate some particular embodiments of the disclosure, and not to exhaustively specify all permutations, combinations and variations thereof.

The present disclosure comprises the syntheses of mono-hydrogen ferrocyanides of the general formula M₃HFe(CN)₆ in which iron has an oxidation number of +2 (ferro) and the positive counter-ion, M, belongs mainly to the group of the alkali metals such as Na+, K+and Li+, or to organic alkyl cations such as imidazole derivatives. This disclosure also refers to the use of such mono-hydrogen ferrocyanides mostly, but not limited, as hydroxyl radical (OH) generators, a Reactive Oxygen Species (ROS) useful in many applications included, but not limited as bactericides, antifungals, antivirals, anticancer agents, as well as in many mechanistic studies in which the hydroxyl radical has been implied such as in antioxidants like vitamin E, enzymatic processes such as catalase and in chemical syntheses where it can serve the dual purpose of a radical in polymerization reactions and as a hydroxylating agent for the production of important chemicals such as E quinone, hydroxyproline, etc., all of this processes having the advantage of the so called green chemistry in which the by-products are clean compounds such as water. An advantage of the compounds included in the present disclosure is the lack of toxicity of the reagents and products, as well as the purity of the hydroxyl radical produced.

### Synthetic Methodology

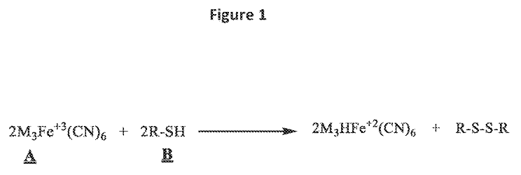

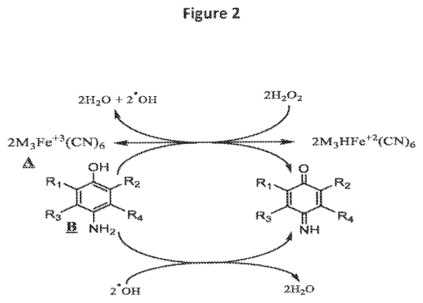

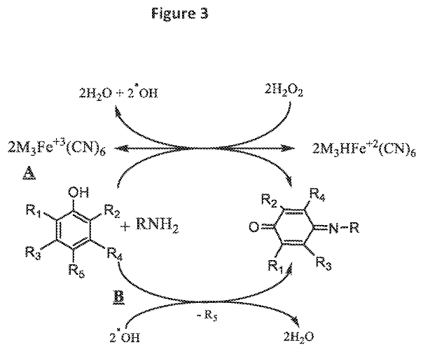

The syntheses of the mono-hydrogen ferrocyanides subject of the current disclosure use two basic reagents. 1) A hydrogen atom acceptor represented by a ferricyanide or hexacyanoferrate (III), component A, and 2) a hydrogen atom donor B, which could be a thiol (FIG. 1), or a phenol or phenol-like moiety in combination with an amino moiety present as an amine or as an amide (schemes II and III). The last two moieties can be present in the same compound as in FIG. 2, or in two separate entities as in FIG. 3.

The groups R1 to R4 can be any moiety containing carbon, oxygen or hydrogen. The group R5 can be hydrogen or any moiety containing oxygen or carbon as the linking atom. The group R can be an aromatic or aliphatic moiety, thus, either a plain or a substituted amine or amide. The group M can be alkali metals such as Na+, K+and Li+, or organic groups like imidazoles, prepared by reacting an alkali metal ferricyanide with the salt of an organic compound such as imidazoles hydrochlorides.

The reactions are examples of green chemistry in which reagents and products are useful compounds and the solvents are water and recoverable acetone and ethyl acetate. The thiols used in this application can be aliphatic or aromatic, a useful example is the amino acid cysteine which produces the disulfide cystine. Examples of phenolic and phenolic-like compounds includes phenol, pyrogallol, catechol, vitamin E, resveratrol, ascorbic acid, etc. Examples of amino compounds includes aniline, hexamine, metformin, butyramide, amino acids and peptides, such as glycine, α-and β-alanine, carnosine, nucleic bases such as adenine, etc. The two variations follow similar syntheses.

### Example 1 Using a Thiol

Potassium ferricyanide (3.29 g) dissolved in 30 ml of distilled water is stirred in a beaker and mixed with 1.21 g of cysteine dissolved in 10 ml of distilled water. The solution becomes a green suspension that after 4 h is filtered off of the white cystine while the clear green filtrate is concentrated under vacuum to give the desired tri-potassium hydrogen ferrocyanide

### Example 2 Using an Amino Phenol

A 50 ml aqueous-acetone (1:1) solution of 1.09 g (0.01 mol, 1X) of p-aminophenol was added to a magnetically stirred solution of 6.6 g (0.02 mol, 2X) of potassium ferricyanide [K₃Fe(CN)₆] in 80 ml of water contained in a 200 ml beaker. After stirring for 2h at room temperature, the red p-imino quinone was extracted 3 times with portions of 20 ml each of ethyl acetate, purified by short-column chromatography and its structure confirmed by NMR and MS. The aqueous phase was concentrated under vacuum to give 6.18 g (94% yield) of a dark green solid, mp 300° C. (dec.), with a MS (M+H) value found of 330.8609 (calc. 330.8596), corresponding to tri-potassium hydrogen ferrocyanide [tri-potassium hydrogen hexacyanoferrate (II)].

### Example 3 Using Separate Amine and Phenol

A 50 ml aqueous acetone (1:1) solution of 1.52 g (0.01 mol, 1X) of trimethyl p-hydroquinone and 0.93 g (0.01 mol, 1X) of aniline were added to a magnetically stirred solution of 13.2 g (0.04 mol, 4X) of potassium ferricyanide [K3Fe (CN) 6] in 80 ml of water contained in a 200 ml beaker. After stirring for 2h at room temperature, the floating oil of yellow p-imino quinone was extracted 3 times with portions of 20 ml each of ethyl acetate, purified by short-column chromatography and its structure confirmed by NMR and MS as trimethyl p-phenylimino quinone (M+H of 226.1226 calculated and observed). The aqueous phase was concentrated under vacuum to give 13.1 g (99% yield) of a green solid, mp 300° C. (dec.), with a MS+1 observed value of 330.8605 (calc. 330.8596), corresponding to tri-potassium hydrogen ferrocyanide [tri-potassium hydrogen hexacyanoferrate (II)].

### Example of the Synthesis of an Organic Ferricyanide

A solution of 0.03 mol (4.63 g) of benzimidazole hydrochloride in 50 ml of water is added to a solution of 0.01 mol (3.39 g) of potassium ferricyanide in 10 ml of water. The yellow precipitate made upon addition is filtered, washed with a small amount of cold water and dried to give 5.38 g (95% yield) of tri-benzimidazole ferricyanide.

### Generation of Hydroxyl Radicals

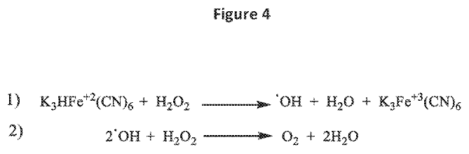

The generation of hydroxyl radicals involves the reaction of the tri-alkali or tri-alkyl mono-hydrogen ferrocyanide with hydrogen peroxide (H₂O₂) shown in equation 1) of FIG. 4. Because the hydroxyl radicals are highly reactive, they must be generated close to where the reaction or use is designed to take place, and the concentration of the H₂O₂ must be kept low to minimize the reaction of the radicals with H₂O₂, a reaction that produces molecular oxygen (0₂) and water as shown in equation 2) of FIG. 4, unless generation of pure molecular oxygen is the desired application.

### Examples of Some Applications of Generated Hydroxyl Radicals

Vial method for evaluation of antioxidants—A 4 ml aqueous solution of the hydroxyl generator is placed in a 12 ml vial and 4 ml of ethyl acetate is added creating a bi-phasic system in which the polar water solution sits at the bottom of the vial. To the nonpolar ethyl acetate is added equimolar amounts of the purported antioxidant to be tested and a nonpolar amine such as aniline. Alternatively, the two materials above can be mixed with ethyl acetate prior to its addition to the water solution. To this bi-phasic system dilute H₂O₂ is added dropwise and slowly, keeping the bubbly formation of O₂ at a minimum. Formation of a color solution in the nonpolar phase confirms the material as an antioxidant of the phenolic type.

Enhancement of H₂O₂ as antibacterial agent—Most of the external action of H₂O₂is bactericidal and is most effective when blood is present. However, that action can be significantly increased and expanded to areas where there is no blood by the addition of the hydroxyl generator. The generator is applied to the area affected as a dry powder or dissolved in water or as a lotion followed by a small amount of the common 4% solution of H₂O₂.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

The foregoing detailed description of the present disclosure is to be understood as being in every respect illustrative and exemplary, but not restrictive, and the scope of the present disclosure provided herein is not to be determined solely from the detailed description, but rather from the claims as interpreted according to the full breadth and scope permitted by patent laws. It is to be understood that the embodiments shown and described herein are merely illustrative of the principles addressed by the present disclosure and that various modifications may be implemented by those skilled in the art without departing from the scope and spirit of the present disclosure. Those skilled in the art may implement various other feature combinations without departing from the scope and spirit of the present disclosure. The various functional modules shown are for illustrative purposes only, and may be combined, rearranged and/or otherwise modified.

What is claimed is:

1. A method of synthesizing tri-potassium hydrogen ferrocyanide (K₃HFe(CN)₆), comprising:
reacting potassium ferricyanide with cysteine in an aqueous solution to produce tri-potassium hydrogen ferrocyanide.

2. The method of claim 1, wherein the reaction is carried out at room temperature.

3. The method of claim 1, wherein the cysteine is dissolved in distilled water before being added to the potassium ferricyanide solution.

4. The method of claim 1, further comprising filtering the green suspension formed during the reaction to separate the cystine by-product.

5. The method of claim 4, further comprising concentrating the filtrate under vacuum to isolate the tri-potassium hydrogen ferrocyanide as a green solid.

6. A method of synthesizing tri-potassium hydrogen ferrocyanide (K₃HFe(CN)₆), comprising:
reacting potassium ferricyanide with 4-aminophenol in an aqueous-acetone solution to produce tri-potassium hydrogen ferrocyanide.

7. The method of claim 6, wherein the 4-aminophenol is dissolved in an aqueous-acetone solution prior to the reaction.

8. The method of claim 6, further comprising purifying the reaction product by chromatography to obtain p-imino quinone as a by-product.

9. The method of claim 8, wherein the structure of p-imino quinone is confirmed by nuclear magnetic resonance (NMR) and mass spectrometry (MS).

10. The method of claim 6, further comprising concentrating the aqueous phase under vacuum to yield the tri-potassium hydrogen ferrocyanide as a dark green solid.

11. A method of synthesizing tri-potassium hydrogen ferrocyanide (K₃HFe(CN)₆), comprising:
reacting potassium ferricyanide with trimethyl p-hydroquinone, followed by a reaction with aniline, to produce tri-potassium hydrogen ferrocyanide.

12. The method of claim 11, wherein the reaction is carried out in an aqueous-acetone solution.

13. The method of claim 11, further comprising purifying the yellow p-imino quinone by-product using chromatography.

14. The method of claim 11, wherein the structure of the p-imino quinone is confirmed by nuclear magnetic resonance (NMR) and mass spectrometry (MS).

15. The method of claim 11, further comprising concentrating the aqueous phase under vacuum to yield tri-potassium hydrogen ferrocyanide as a green solid.

16. A method for generating hydroxyl radicals, comprising reacting tri-substituted mono-hydrogen ferrocyanides of the formula M₃HFe(CN)₆ with hydrogen peroxide to produce hydroxyl radicals, wherein M is selected from the group consisting of alkali metals and organic alkyl cations.

17. The method of claim 16, wherein the hydroxyl radicals are generated close to the location where the reaction or application is intended to take place.

18. The method of claim 16, wherein the concentration of hydrogen peroxide is controlled to minimize the reaction of the hydroxyl radicals with hydrogen peroxide, thereby limiting the production of molecular oxygen.

19. A method of using tri-substituted mono-hydrogen ferrocyanides of the formula M₃HFe(CN)₆ for evaluating antioxidant properties, comprising:
combining the tri-substituted mono-hydrogen ferrocyanides with hydrogen peroxide to produce hydroxyl radicals;
adding a test antioxidant to the reaction; and
observing the effect of the antioxidant on hydroxyl radical activity.
